(19) United States
(12) Patent Application Publication
(10) Pub. No.: US 2005/0064917 A1
(43) Pub. Date: Mar. 24, 2005

(54) Mobile phone with twin rotational shafts

(76) Inventors: Chun-Chieh Peng, Taipei City (TW); Gwo-Chyuan Chen, Taipei City (TW)

Correspondence Address: RABIN & BERDO, P.C., Suite 500, 1101 14 Street, N.W., Washington, DC, 20005, US

(21) Appl. No.: 10/935,214

(22) Filed: Sep. 8, 2004

(30) Foreign Application Priority Data
Sep. 18, 2003 (TW) 92216781

(51) Int. Cl. H04M 1/00

(52) U.S. Cl. 455/575.1

(57) ABSTRACT

A mobile phone with twin rotational shafts is described. The mobile phone has a front module, a rear module, and a first rotational shaft. The front module further has a display and a second rotational shaft. The rear module further has a set of keys and/or an image sensing unit. The first rotational shaft allows the front module to rotate about 360 degrees on the second module. The second rotational shaft allows the display to rotate about 360 degrees thereon. A rotation direction of the first rotational shaft is about parallel to a picture-taking direction of the image sensing module and perpendicular to a rotation direction of the second rotational shaft. A movement direction of the set of keys is about parallel to the picture-taking direction of the image sensing module.

### BACKGROUND

1. Field of the Invention

The present invention relates to a mobile phone with twin rotational shafts, and, more particularly, to a mobile phone with twin rotational shafts and an image sensing unit.

2. Description of Related Art

The telecommunication industry is expanding very quickly, and the wireless telecommunication industry is growing especially rapidly. Every telecommunication company is vying for a larger share of the market. In addition, with the progress in electronic and semiconductor technology, the mobile phone is designed toward a smaller outline and a lighter weight. Further, the functions of the mobile phone change with each passing day, for example, sending newsletters and e-mail, accessing internet and playing games. Furthermore, a powerful mobile phone can be combined with personal digital assistant (PDA) functions.

Currently, a mobile phone with a color display is a mainstream product in the market. The demand for mobile phones combined with digital cameras comes with the tide of fashion. Manufacturing a suitable image sensing unit for installation in the mobile phone is an important objective for mobile phone manufacturers. Therefore, manufacturing technologies and size of the image sensing unit are improved every day. An image sensing unit installed in a mobile phone is not complicated technology because an image sensing unit is designed with a smaller size. Generally speaking, the image sensing unit of the mobile phone is installed in a side opposite the display; for example, the image sensing unit is installed in a back shell of a bar-type unit, or the image sensing unit is installed in a back side of a lower shell and the display is installed on an interior surface of an upper shell of a clamshell-type unit.

However, the image sensing unit installed in a back side of the mobile phone can allow a user to monitor directly the image on the display when taking pictures. Comparing the clamshell-type with the bar-type, some of the clamshell-types can allow the user to look at the display while taking a self-portrait. Therefore, the clamshell-type mobile phone can provide additional conveniences and application scopes.

Although the clamshell-type mobile phone can provide additional conveniences and application scopes, the image sensing unit and the color display of the clamshell-type mobile phone do not completely matched up with each other. Accordingly, a digital camera or digital camcorder on a mobile phone cannot bring all functions into full play.

Currently, a user not only needs a good mobile phone with a good communication function but also need a mobile phone having an easily controlled digital camera or digital camcorder for processing and inputting multimedia images, and a convenient and clear display for monitoring and displaying the images.

### SUMMARY OF THE INVENTION

One object of the present invention is to provide a rotational shaft structure for a mobile phone to improve the combination structure of the image sensing unit and the display so that the display allows the user to take picture at any position and angle with the image sensing unit.

Another object of the present invention is to provide a rotational shaft structure for a mobile phone, whereby the display cooperates with the image sensing unit for previewing an image captured by the image sensing unit while taking a portrait, a landscape, or a self-portrait. Accuracy of the picture can thus be enhanced.

A further object of the present invention is to provide a mobile phone with a rotational shaft structure to adjust an image content of a picture captured by the image sensing unit according to a view angle of the display, so that the display completely cooperates with the image sensing unit.

To accomplish the above objectives, the present invention provides a mobile phone with twin rotational shafts. The mobile phone has a rear module, a front module, and a first rotational shaft. The rear module has an image sensing unit, and the front module has a display and a second rotational shaft. The first rotational shaft is coupled between the rear module and the front module, and enables the front module to rotate up to about 360 degrees on the rear module. The second rotational shaft is coupled between the display and the first rotational shaft, and enables the display to rotate up to about 360 degrees on the second rotational shaft. Therefore, the display is capable of rotating on the first rotational shaft. A rotation direction of the first rotational shaft is about parallel to a picture-taking direction of the image sensing unit, and perpendicular to a rotation direction of the second rotational shaft.

The rear module further has a keyboard and a movement direction of the keyboard is about parallel to the picture-taking direction of the image sensing unit. The keyboard is, for example, a set of numerical keys for dialing telephone numbers. The image sensing unit is a charge-coupled device (CCD), or a complementary metal oxide semiconductor (CMOS).

Another aspect of the invention is to provide a mobile phone with twin rotational shafts. The mobile phone with twin rotational shafts includes a rear module, a front module, and a first rotational shaft. The rear module includes a set of keys, and the front module includes a display and a second rotational shaft. The first rotational shaft is coupled between the rear module and the front module, and enables the front module to rotate up to about 360 degrees on the rear module. The second rotational shaft is coupled between the display and the first rotational shaft, and enables the display to rotate up to about 360 degrees on the second rotational shaft. Therefore, the display is capable of rotating on the first rotational shaft. A rotation direction of the first rotational shaft is about parallel to a movement direction of the set of keys, and perpendicular to a rotation direction of the second rotational shaft.

The rear module further has an image sensing unit and the movement direction of the set of keys is about parallel to a picture-taking direction of the image sensing unit.

The mobile phone with twin rotational shafts according to the present invention utilizes a first rotational shaft to allow the front module to rotate parallel to the picture-taking direction of the image sensing unit. Furthermore, the second rotational shaft allows the display to rotate in the front module. Therefore, the mobile phone with twin rotational shafts according to the present invention provides a preferred combination structure of the image sensing unit and the display. Accordingly, users can take pictures with more choices of angles of the display and directions for taking pictures so that the mobile phone can provide a better and accurate display image on the display thereof for conveniently taking pictures.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1A is a front view of a preferred embodiment of a mobile phone with twin rotational shafts according to the present invention;

FIG. 1B is a rear view of the preferred embodiment illustrated in FIG. 1A;

FIG. 2A is a schematic view of a front module, rotated 90 degrees around the first rotational shaft, of the preferred embodiment illustrated in FIG. 1A;

FIG. 2B is a schematic view of a front module, rotated 180 degrees around the first rotational shaft, of the preferred embodiment illustrated in FIG. 1A;

FIG. 3A is a schematic view of a display, rotated 45 degrees around the second rotational shaft, of the preferred embodiment illustrated in FIG. 2B;

FIG. 3B is a schematic view of a display, rotated 180 degrees around the second rotational shaft, of the preferred embodiment illustrated in FIG. 2B;

FIG. 4A is a schematic view of a display, rotated up 45 degrees around the second rotational shaft, of the preferred embodiment illustrated in FIG. 2A;

FIG. 4B is a schematic view of a display, rotated down 45 degrees around the second rotational shaft, of the preferred embodiment illustrated in FIG. 2A; and

FIG. 4C is a schematic view of a display, rotated 180 degrees around the second rotational shaft, of the preferred embodiment illustrated in FIG. 2A; and

### DETAILED DESCRIPTION OF THE PREFERRED EMBODIMENT

The following description is of the best presently contemplated mode of carrying out the present invention. This description is not to be taken in a limiting sense but is made merely for the purpose of describing the general principles of the invention. The scope of the invention should be determined by referencing the appended claims.

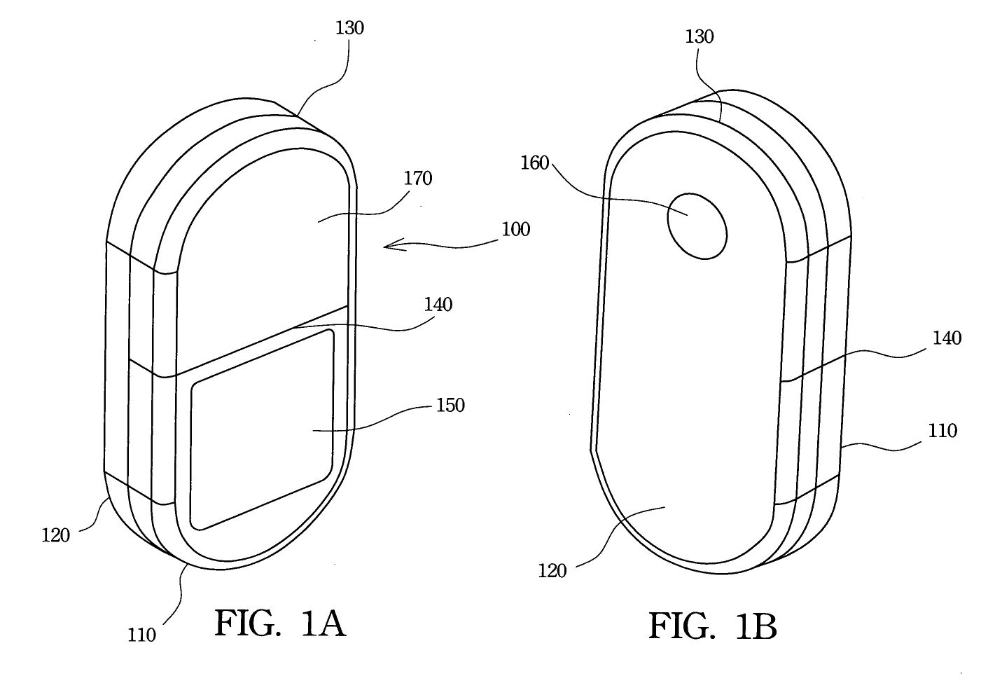

FIG. 1A is a front view of a preferred embodiment of a mobile phone with twin rotational shafts according to the present invention, and FIG. 1B is a rear view thereof. The mobile phone 100 with twin rotational shafts according to the present invention includes a first rotational shaft 130, and a second rotational shaft 140. The first rotational shaft 130 couples a front module 110 to a rear module 120 so that the front module 110 and the rear module 120 can mutually rotate thereon; a rotational angle therebetween can reach about 360 degrees. The front module 110 includes a display 150, a front module base 170, and a second rotational shaft 140 coupled therebetween. Accordingly, the display 150 can rotate around the second rotational shaft 140 on the front module base 170, and a rotational angle thereof can reach about 360 degrees.

Referring to FIG. 1B, an image sensing unit 160 for capturing images is configured in the rear module 120, that is to say, a rear side of the mobile phone 100. The image sensing unit 160 can be a digital still camera for taking a still image and/or a video camcorder for taking moving pictures. The image sensing unit 160 is a charge-coupled device (CCD) or a complementary metal oxide semiconductor (CMOS).

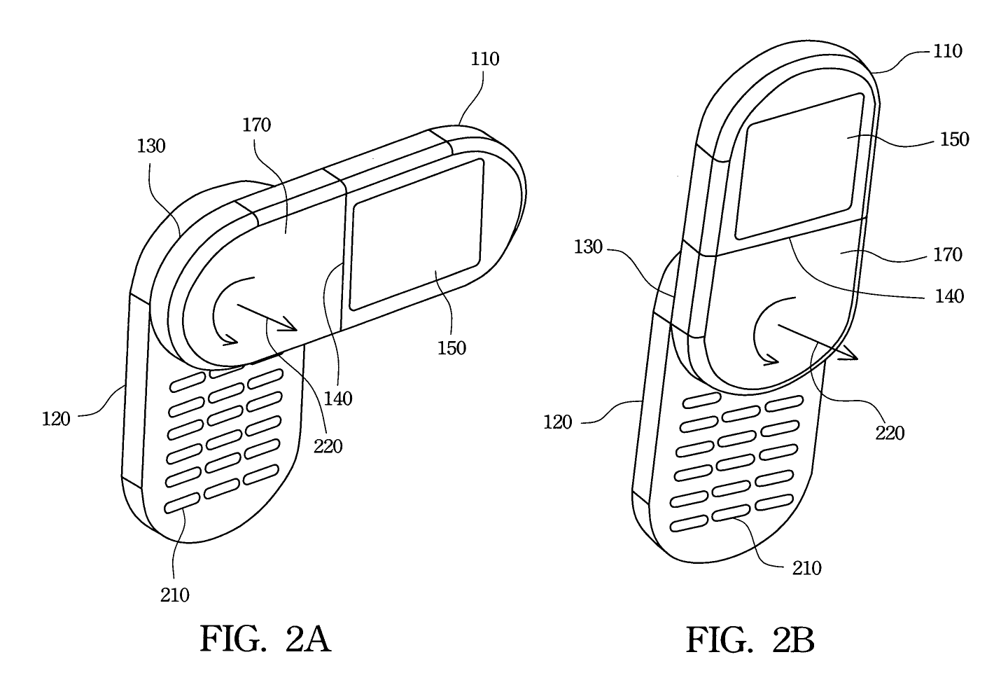

FIG. 2A is a schematic view of a front module, rotated 90 degrees around the first rotational shaft, of the preferred embodiment of FIG. 1A, and FIG. 2B illustrates the front module rotated 180 degrees. The first rotational shaft 130 allows the front module 110 to rotate along a surface on keys 210; that is to say, a rotation direction 220 of the first rotational shaft 130 is parallel to a movement direction of the keys 210. Therefore, the front module 110 can utilize the first rotational shaft 130 to rotate approximately 360 degrees on the rear module 120; the rotation can be a clockwise 360 degrees, a counter-clockwise 360 degrees, a clockwise 180 degrees or a counter-clockwise 180 degrees. The keys 210 include a numerical keyboard for dialing telephone numbers and/or any other function keys. The keys 210 and the image sensing unit 160 are installed in two opposite surfaces of the rear module 120.

Because the front module 110 can rotate about 360 degrees on the first rotational shaft 130, the display 150 of the front module 110 can also rotate on the first rotational shaft 130. Further, the front module 110 can protect the keys 210. The image sensing unit 160 disposed in the rear side of the mobile phone 100 with twin rotational shafts can take pictures in a direction parallel to the movement direction of the keys 210. Accordingly, the display 150 can rotate about 360 degrees in the direction for taking picture of the image sensing unit 160. Referring to FIG. 2A, when the front module 110 rotates about 90 degrees around the first rotational shaft 130, the display 150 becomes a horizontal display. Generally speaking, most still pictures and moving pictures exist with the horizontal images for visual effects and general image displays, for example, computer monitors or televisions.

A conventional clamshell-type mobile phone normally uses a vertical display installed in an upper shell so as to provide a larger display. If the clamshell-type mobile phone selects a horizontal display, the horizontal display is limited by the left-right boundary of the mobile phone, and therefore the display size has to be reduced.

In the mobile phone 100 with twin rotational shafts according to the present invention, the rotation direction 220 of the first rotational shaft 130 is parallel to the picture-taking direction of the image sensing unit 160. Therefore, the picture-taking direction of the image sensing unit 160 is not limited to the direction of the display 150. The display 150 of the front module 110 can rotate along the first rotational shaft 130 to match the image sensing unit 160. Furthermore, the display 150 can adjust and display the image according to the rotational angle thereof to demonstrate a preferred display effect from a different angle.

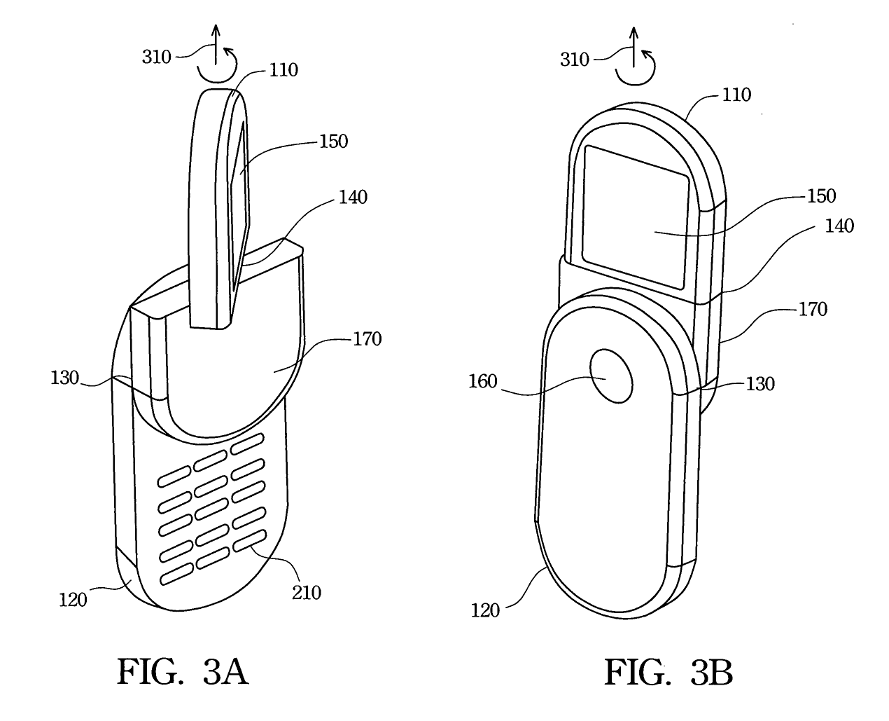

FIG. 3A is a schematic view of a display, rotated 45 degrees around the second rotational shaft, of the preferred embodiment illustrated in FIG. 2B. When the front module 110 is rotated about 180 degrees around the first rotational shaft 130, the display 150 can rotate around the second rotational shaft 140 so that the display 150 can be arbitrarily rotated from left to right and/or from front to rear. Therefore, the second rotational shaft 140 allows the display 150 to rotate in a direction perpendicular to the first rotational shaft 130. That is to say, the rotation direction 310 of the second rotational shaft 140 is perpendicular to the rotation direction 220 of the first rotational shaft 130. Referring to FIG. 3A, the display 150 faces the right side of the drawing. In FIG. 3B, the display 150 is rotated to a rear side of the mobile phone with twin rotational shafts. Accordingly, the display 150 and the image sensing unit 160 both face a same direction. Therefore, a user can take a picture of a self-portrait, monitor the image, and check the taken picture quality immediately.

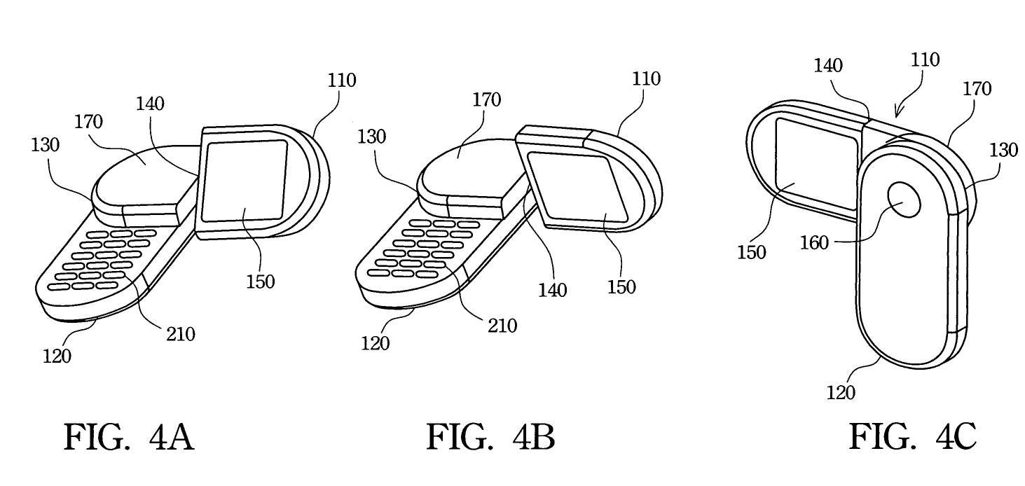

FIGS. 4A, 4B, and 4C illustrate the display of the preferred embodiment of FIG. 2A rotated up 45 degrees, down 45 degrees, and 180 degrees around the second rotational shaft, respectively. The display 150 can be rotated in arbitrary directions because the mobile phone combines the first rotational shaft 130 and the second rotational shaft 140 perpendicular to the first rotational shaft 130. Therefore, the display can be rotated a little bit up or down, and even directly to the back side of the mobile phone for taking a self-portrait. The display can therefore provide a better image display for the image sensing unit 160 of the mobile phone with twin rotational shafts.

In the conventional mobile phone, the image sensing unit and the display sometimes fail to match each other, at some particular angles. The mobile phone with twin rotational shafts according to the present invention can provide a more cooperative assembly. The display can be rotated in any direction for the image sensing unit to take pictures, and the display can furthermore be rotated to a better view angle to avoid an unclear display caused by excessive or insufficient light. Therefore, the display of the mobile phone with twin rotational shafts can be set at a better view angle for taking pictures by the image sensing unit.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

1. A mobile phone with twin rotational shafts, comprising:
a rear module with an image sensing unit;
a front module with a display and a second rotational shaft; and
a first rotational shaft coupled between the rear module and the front module, a rotation direction of the first rotational shaft being parallel to a picture-taking direction of the image sensing unit, wherein the front module rotates on the rear module via the first rotational shaft within a first predetermined angle;
wherein the second rotational shaft is coupled between the first rotational shaft and the display, a rotation direction of the second rotational shaft forms a second predetermined angle with the rotation direction of the first rotational shaft, and the display rotates on the second rotational shaft within a third predetermined angle.

2. The mobile phone with twin rotational shafts of claim 1, wherein the rear module further comprises a keyboard, and a movement direction of the keyboard is about parallel to the picture-taking direction of the image sensing unit.

3. The mobile phone with twin rotational shafts of claim 2, wherein the keyboard comprises a set of numerical keys for dialing telephone numbers.

4. The mobile phone with twin rotational shafts of claim 1, wherein the front module further comprises a front module base coupled between the first rotational shaft and the second rotational shaft.

5. The mobile phone with twin rotational shafts of claim 1, wherein the image sensing unit comprises a charge-coupled device (CCD).

6. The mobile phone with twin rotational shafts of claim 1, wherein the image sensing unit comprises a complementary metal oxide semiconductor (CMOS).

7. The mobile phone with twin rotational shafts of claim 1, wherein the first predetermined angle is about 0 degree to 360 degrees.

8. The mobile phone with twin rotational shafts of claim 1, wherein the second predetermined angle is about 90 degrees.

9. The mobile phone with twin rotational shafts of claim 1, wherein the third predetermined angle is about 0 degree to 360 degrees.

10. A mobile phone with twin rotational shafts, comprising:
a rear module with a set of keys;
a front module with a display and a second rotational shaft; and
a first rotational shaft coupled between the rear module and the front module, a rotation direction of the first rotational shaft being parallel to a movement direction of the set of keys, wherein the front module rotates on the rear module via the first rotational shaft within a first predetermined angle;
wherein the second rotational shaft is coupled between the first rotational shaft and the display, a rotation direction of the second rotational shaft forms a second predetermined angle with the rotation direction of the first rotational shaft, and the display rotates on the second rotational shaft within a third predetermined angle.

11. The mobile phone with twin rotational shafts of claim 10, wherein the set of keys comprises a set of numerical keys for dialing telephone numbers.

12. The mobile phone with twin rotational shafts of claim 10, wherein the rear module further comprises an image sensing unit, wherein a picture-taking direction of the image sensing unit is about parallel to the movement direction of the set of keys.

13. The mobile phone with twin rotational shafts of claim 12, wherein the image sensing unit comprises a charge-coupled device (CCD).

14. The mobile phone with twin rotational shafts of claim 12, wherein the image sensing unit comprises a complementary metal oxide semiconductor (CMOS).

15. The mobile phone with twin rotational shafts of claim 10, wherein the first predetermined angle is about 0 degree to 360 degrees.

16. The mobile phone with twin rotational shafts of claim 10, wherein the second predetermined angle is about 90 degrees.

17. The mobile phone with twin rotational shafts of claim 10, wherein the third predetermined angle is about 0 degree to 360 degrees.

18. A mobile phone with twin rotational shafts, comprising:
a rear module with a set of keys and a image sensing unit, wherein a picture-taking direction of the image sensing unit is about parallel to a movement direction of the set of keys, the set of keys and the image sensing unit being disposed on opposite sides of the rear module, respectively;
a front module with a display, a front module base and a second rotational shaft, wherein the second rotational shaft is coupled between the display and the front module base so that the display rotates on the front module base between about 0 degree to about 360 degrees; and
a first rotational shaft coupled between the rear module and the front module, a rotation direction of the first rotational shaft being about parallel to the picture-taking direction of the image sensing unit, and about perpendicular to a rotation direction of the second rotational shaft, wherein the front module rotates on the rear module via the first rotational shaft between about 0 degree to about 360 degrees.

19. The mobile phone with twin rotational shafts of claim 18, wherein the set of keys comprises a set of numerical keys for dialing telephone numbers.

20. The mobile phone with twin rotational shafts of claim 18, wherein the image sensing unit is a charge-coupled device (CCD) or a complementary metal oxide semiconductor (CMOS).
